(19) United States
(12) Patent Application Publication
(10) Pub. No.: US 2020/0305567 A1
(43) Pub. Date: Oct. 1, 2020

(54) COMBINATION TRAVEL LUGGAGE AND BOOSTER SEAT

(71) Applicants: Hoe Ping Lo, Doncaster (AU); Cheng Tack Lee, Doncaster (AU)

(72) Inventors: Hoe Ping Lo, Doncaster (AU); Cheng Tack Lee, Doncaster (AU)

(21) Appl. No.: 16/830,193

(22) Filed: Mar. 25, 2020

Related U.S. Application Data
(60) Provisional application No. 62/823,387, filed on Mar. 25, 2019.

(51) Int. Cl. A45C 9/00; A45C 13/38; A47D 1/10

(52) U.S. Cl. CPC A45C 9/00; A45C 13/385; B60N 2/2848; A45C 2009/002; A47D 1/10

(57) ABSTRACT

A combination includes a luggage piece having a booster seat removably mounted thereupon. The luggage includes a housing adapted to contain belongings, wheels for rolling movement, and a retractable luggage handle. The booster seat forms a seat having an upper surface adapted for the child to sit upon. First and second securing mechanisms enable the booster seat to be removably mounted on the luggage, until released by a release device.

### CROSS-REFERENCE TO RELATED APPLICATIONS

This application for a utility patent claims the benefit of U.S. Provisional Application No. 62/823,387, filed Mar. 25, 2019.

### BACKGROUND OF THE INVENTION

### Field of the Invention

This invention relates generally to travel luggage, and more particularly to travel luggage that is adapted to seat and secure a child while traveling via a removable booster seat.

### Description of Related Art

Bacon, U.S. Pat. No. 7,918,502, teaches wheeled luggage that includes a child car seat mounted on the front surface of luggage. Straps enable a detachable function of the car seat, as well as secure a child in place. This luggage is similar to the present invention in that a child may ride in a detachable seat mounted on rolling luggage with securing straps, and the seat may be removed for use as a car seat. Differences include the fact that the seat is attached to the front of the luggage, not on top. Further, the car seat is larger than a typical booster seat and therefore functionally different.

Wilson, U.S. Pat. No. 7,293,792, teaches a transportable booster seat and optional carrying bag. The booster seat serves as the roller bottom of a carrying case, with optional arms on respective sides of the seat cushion, and a retractable handle attached to the booster seat. Unlike the present invention, the booster seat is on the underside of the carrying bag. The carrying bag has at least one storage compartment and a top strap adapted fit over the retractable handle of the booster seat. Both inventions teach a transportable booster seat, but adapted to different methods of construction.

Another patent that is similar to the present invention is Lenz, U.S. Pat. No. 6,241,313, which teaches a child seat for removable attachment on the front panel of a luggage piece, not to rest on the top as in the present invention. The seat includes a collapsible frame structure formed and configured to support a seat base, a back rest, opposite arm rests, and a front leg support extending downwardly from the seat base. Adjustable strap members and a harness extend from the frame structure to secure a child in the seat. The present invention is similar to Lenz in that both teach a child seat adapted to fit over a luggage piece.

Mahvi, U.S. Pat. No. 5,234,143, teaches a multipurpose traveling bag comprising a primary bag section and a removable auxiliary bag section. The primary bag section can be hand carried, rolled, or worn as a backpack with or without the removable auxiliary bag section. The primary bag section has a fold down seat that can be used as a booster seat by infants or a seat for adults, in respective embodiments. The fold down seat is different than the present invention's detachable booster seat, but both teach travel bags that allow seating.

Similar to Wilson, Kau, U.S. 20050168026, teaches a travel pack and detachable child safety seat. A backpack and shoulder harness system is removably attached to the child safety seat for carrying the child safety seat on one's back. Like Wilson, the seat serves as the bottom portion when in an assembled configuration, unlike the present invention. Further, Kau is not adapted for rollable transportation.

### SUMMARY OF THE INVENTION

The present invention teaches certain benefits in construction and use which give rise to the objectives described below.

The present invention provides a combination travel luggage and booster seat for carrying both belongings and a child. The combination includes a luggage piece and a booster seat removably mounted thereupon. The luggage piece includes a housing adapted to receive and contain the belongings; wheels mounted on the housing; a first securing mechanism mounted on the housing; and a luggage handle attached to the housing. The booster seat includes a seat adapted for the child to sit upon; restraint straps attached to the booster seat adapted for holding the child on the seat; a second securing mechanism on a bottom surface of the booster seat that removably engages the first securing mechanism of the luggage piece so that the booster seat may be removably mounted on the luggage piece; and a release device for releasing the first and second securing mechanisms so that they may be disengaged for removing the booster seat from the luggage piece.

A primary objective of the present invention is to provide a combination travel luggage and booster seat having advantages not taught by the prior art.

Another objective is to provide a combination that includes a booster seat which is removably mounted on a luggage piece so that a child may sit on the booster seat and ride upon the luggage piece.

Another objective is to provide a combination that includes a booster seat that includes restraint straps for holding the child in the booster seat while it is on the luggage piece.

A further objective is to provide a combination that is easy to use.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a perspective view of one embodiment of a combination travel luggage and booster seat, showing a child sitting in a booster seat mounted on a luggage piece;

FIG. 2 is an exploded perspective view of the combination, illustrating a back support of the booster seat in an open position;

FIG. 3 is a perspective view of the combination of FIG. 1, illustrating the back support in a closed position;

FIG. 4 is a rear elevational view thereof, showing a pair of rear wheels mounted on rear legs, the rear legs being in an upright position wherein the pair of rear wheels are adjacent a rear edge of the luggage piece; and

FIG. 5 is a side elevational view thereof, showing the rear legs in a reclining position wherein the pair of rear wheels are spaced a distance from the rear edge.

### DETAILED DESCRIPTION OF THE INVENTION

The above-described drawing figures illustrate one embodiment of the invention, a combination travel luggage and booster seat 10 for carrying both personal belongings 12 and a child while on a journey.

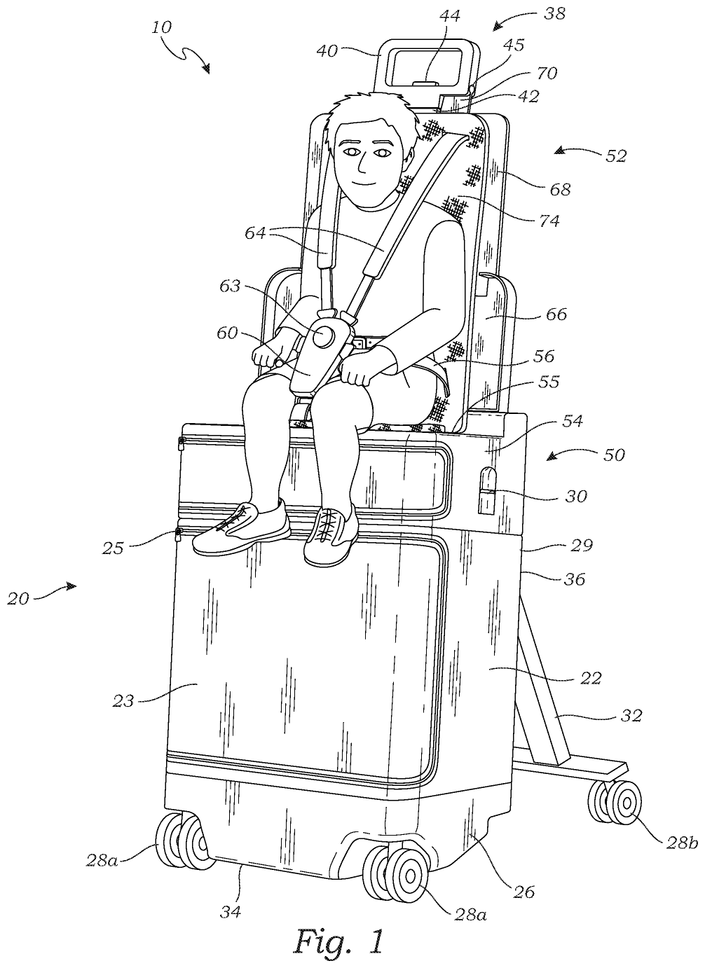

FIG. 1 is a perspective view of the combination travel luggage and booster seat 10. As shown in FIG. 1, the combination 10 includes a luggage piece 20 upon which is removably mounted a booster seat 50. The booster seat 50 is adapted to be removably mounted on the luggage piece 20 so that the booster seat 50, and the child sitting therein, are operably supported on the luggage piece 20 so that they may be carried along with the luggage 20, on wheels 28 of the luggage piece 20, described in greater detail below.

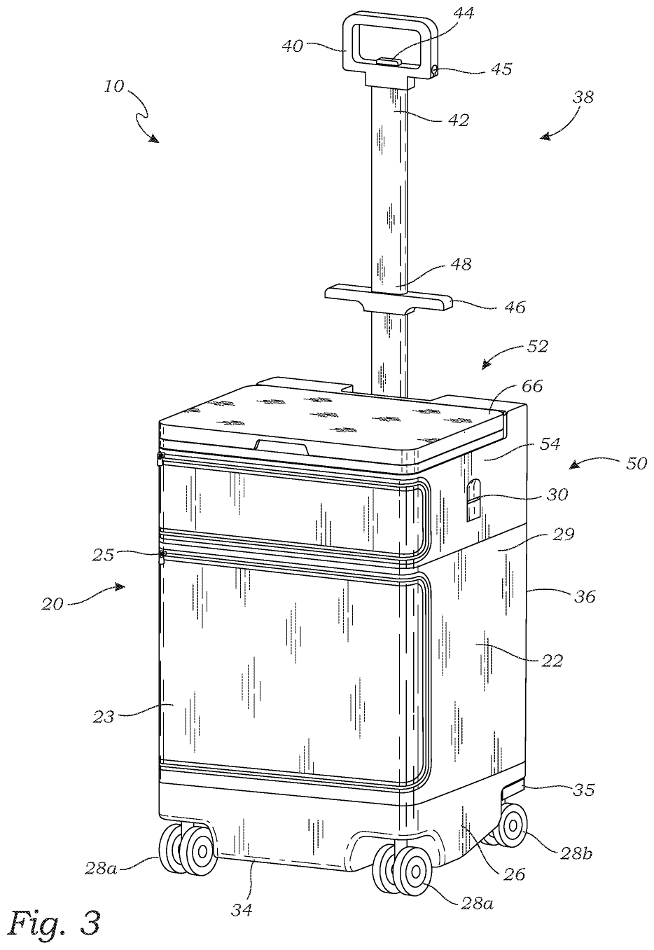

The luggage piece 20 may be in a form that is generally similar to a standard roller suitcase, or any other form of similar bag or luggage known in the art, but which is adapted as noted below for the purposes of this invention. The luggage piece 20 comprises a housing 22 adapted to receive and contain the personal belongings 12 (being shown in FIG. 3), in this embodiment via closable compartments 24 having cover faces 23 which may be closable by fasteners (e.g., zipper, etc.) 25. The housing 22 may further contain the personal belongings 12 via another means, e.g., pouches, drawers, etc. In some embodiments, the booster seat 50 may also have a compartment with a fastener, or other similar structure for holding the personal belongings 12.

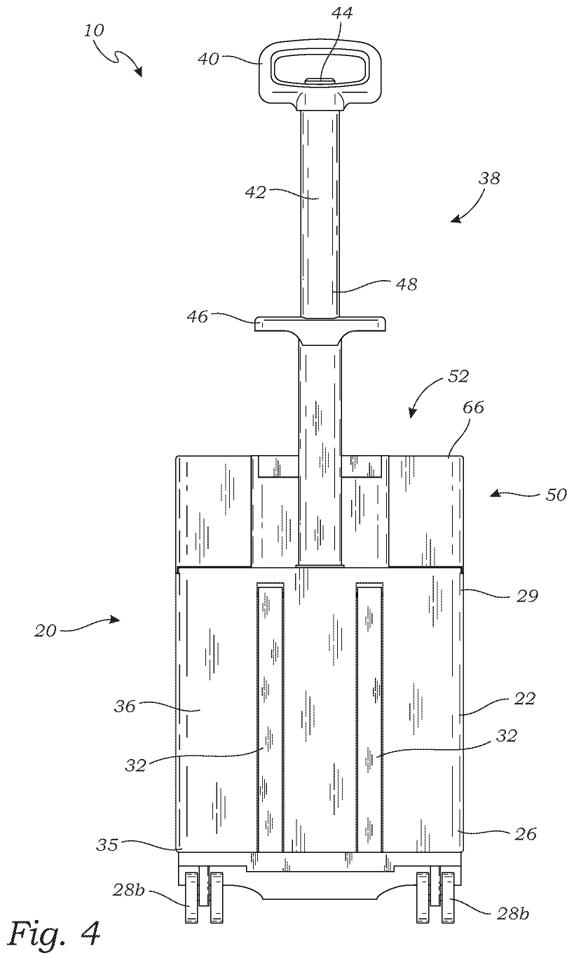

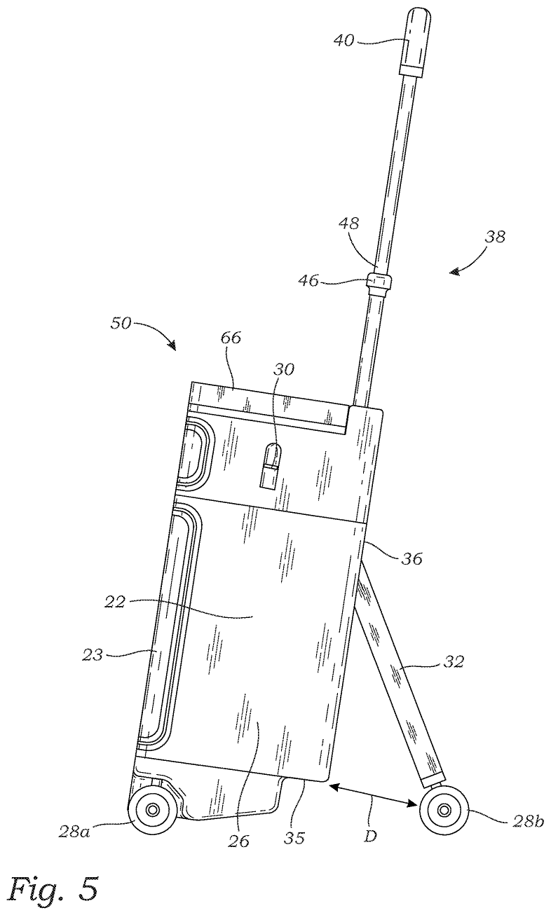

The housing 22 is supported upon wheels 28 mounted on a lower portion 26 of the housing 22. In this embodiment, the wheels 28 include a pair of forward wheels 28a that are mounted adjacent a forward edge 34 of the luggage piece, and a pair of rear wheels 28b which are mounted on rear legs 32 on a back portion 36 of the housing 22, best shown in FIGS. 4-5 and discussed in greater detail below. While one arrangement and type of wheels is illustrated, any number of and arrangement of wheels known in the art may be used, consistent with the teachings of this specification.

The housing 22 further has a retractable luggage handle 38 comprising a grip portion 40 mounted on at least one rod 42 which slidably engages with the housing 22. In other embodiments, the luggage handle 38 may be rotatably mounted on the luggage piece 20, or attached via any construction known in the art. In this embodiment, the retractable luggage handle 38 comprises only one rod 46, but in other embodiments, the luggage handle 38 may comprise two or more rods, or other equivalent structures. The retractable luggage handle 38 may feature a locking mechanism that prevents the luggage handle 38 from unintentionally retracting, and may be operated by a release mechanism 44 on the luggage handle 32. Said release mechanism 44 may be in the form of a push button, a slider, or any other release mechanism known to those skilled in the art. The retractable luggage handle 38 may further include a cross grip 46 located on an approximate middle 48 of the rod 42, as shown in FIG. 3.

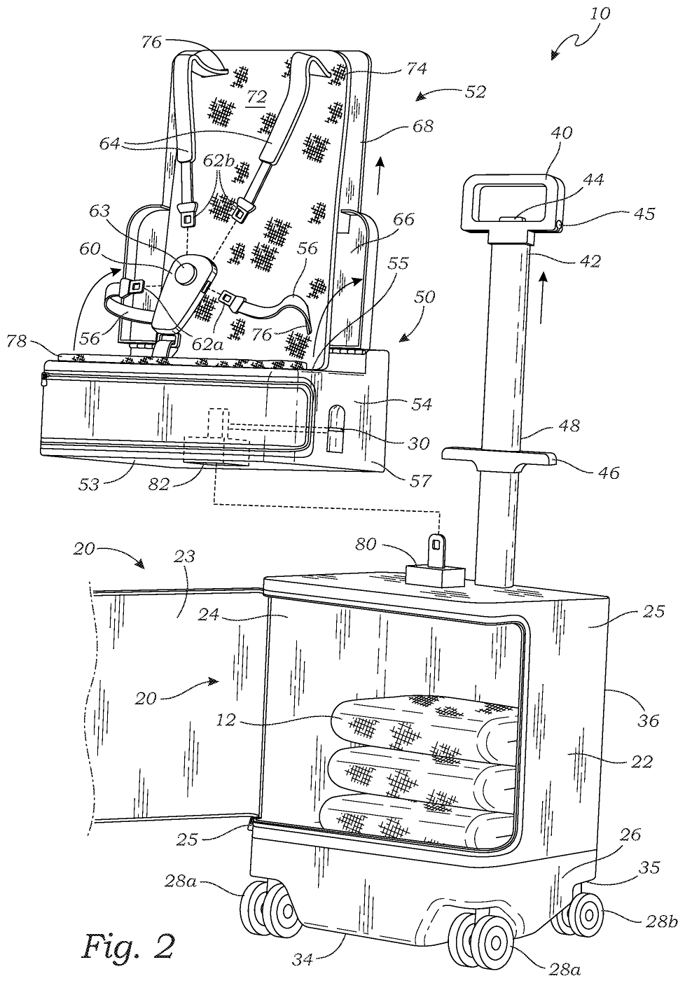

FIG. 2 is an exploded perspective view of the combination travel luggage and booster seat 10, illustrating a back support 52 in an open position, and FIG. 3 is a perspective view thereof, showing the back support 52 in a closed position. As shown in FIGS. 1-3, the back support 52 may be constructed of one or more support plates or members, which may be partially supported by the retractable luggage handle 38 and attach to a receiver 45 of the grip portion 40, described in greater detail below. Other structures may also be provided along with the luggage handle 38, as devisable by one with standard skill in the art.

The booster seat 50 is adapted to be used while attached to the luggage piece 20, or used separately, such as on a seat of a car, plane, bus, etc., or a restaurant, etc., while traveling. The booster seat 50 may be manufactured from any material known in the art that is strong enough to support the child, yet lightweight, for ease of carrying (e.g., plastic, or other suitable materials known in the art). The booster seat 50 comprises a seat 54 having an upper surface 55 adapted for the child to sit upon, and restraint straps 56 attached to the booster seat 50 adapted for holding the child on the seat. In this embodiment, a buckle housing 60 is attached to the seat 54, which receives buckles 62a of the restraint straps 56.

The buckle housing 60 may further receive buckles 62b of shoulder straps 64 attached to the back support 52. The shoulder straps 64 extend from the back support 50 and join together at the buckle housing 60, so that when the child is sitting on the booster seat 50, the shoulder straps 64 will cross over his/her shoulders, and the restraint straps 56 will cross over his/her lap, so the buckles 62a and 62b can secure in the buckle housing 60. The buckle housing 60 may be generally similar to any standard male/female buckle construction, being capable of releasing the buckles 62a and 62b via a release mechanism 63 such as a depressible button, or any other release mechanism known to those skilled in the art, e.g., a latch, switch, etc. The straps 56 and/or 64 may further be fastened together via another means, e.g., a hook and loop fastener, clip, or other related construction.

In this embodiment, the back support 52 comprises a cover plate 66 hingably attached to the booster seat 50, the cover plate 66 having an extension panel 68 and a locking piece 70, the extension panel 68 and locking piece 70 being telescopically engaged with the cover plate 66, respectively. The back support 52 moves from a closed position in which the extension panel 68 and locking piece 70 are recessed into the cover plate 66 and the cover plate 66 is folded over the seat, shown in FIG. 3, to an open position in which the back support 52 provides a front surface 72 that is generally perpendicular to the upper surface 55 of the seat 54, and the extension panel 68 and locking piece 70 further extend upwardly out of the cover plate 66. As shown in FIG. 1, the locking piece 70 is adapted to engage with the receiver 45 of the grip portion 40 of the retractable luggage handle 38.

For the purposes of this application, “perpendicular” is defined to mean any angle which may be approximated as ninety degrees, but which may be greater or less than this, as long as the construction is suitable for the child being seated in the booster seat 50. In one embodiment, this is between seventy-five and one hundred and ten degrees; further, the portions which are perpendicular may not create perfectly even or straight lines, merely extend in a generally perpendicular fashion respective to one another. Some curvature may be preferred for the comfort of the child seated therein.

In this embodiment, a foldable cushion 74 extends across the front surface 72 of the back support 52, the foldable cushion 74 including slots 76 for feeding through the straps 56 and 64. The upper surface 55 of the seat 54 may further include some form of padding 78, which may be separate or integrally formed/attached to the foldable cushion 74.

In this embodiment, the retractable luggage handle 38 of the luggage piece 20 extends upwardly behind the booster seat 50 so that the back support 52 is supported at a suitable height for supporting the child and ensuring he/she does not fall backward while sitting on the combination travel luggage and booster seat 10. As shown in FIG. 3 and discussed above, the retractable luggage handle 38 may further include the cross grip 46 located on the middle 48 of the rod 42.

As shown in FIG. 2, the combination 10 includes a first securing mechanism 80 mounted on an upper portion 29 of the luggage housing 22, and a second securing mechanism 82 on a bottom surface 53 of the booster seat 50 that removably engages the first securing mechanism 80 of the luggage piece 20 so that the booster seat 50 may be removably mounted on the luggage piece 50. The securing mechanisms 80 and 82 in this embodiment include a male engagement mechanism and a female receiving mechanism, respectively, which interlock to securely hold the booster seat 50 on the luggage piece 20. However, in some embodiments, the male and female mechanisms are reversed on the luggage piece 20 and the booster seat 50. While one embodiment of the securing mechanisms 80 and 82 is illustrated, other forms of securing mechanisms (e.g., hooks, clips, rails, mechanical interlocking mechanisms, and non mechanical mechanisms such as magnets, etc.) known in the art suitable for removable assembly of the luggage piece 20 and the booster seat 50 should be considered within the scope of the present invention. Additional safety locking mechanisms (not shown) may also be included so that accidental disconnection is avoided.

As mentioned above, the combination 10 may further include the release device 30 for releasing the first and second securing mechanisms 80 and 82 so that they may be disengaged for removing the booster seat 50 from the luggage piece 20. In this embodiment, the release device 30 is in the form of a slidable latch on a side surface 57 of the booster seat 50, but in other embodiment, the release device 30 may be in the form of any release mechanism known to those in the art (e.g., pull-handles, spring-latches, buttons, etc.), and may be located on any suitable surface of the booster seat 50 or luggage piece 20.

FIG. 4 is a rear elevational view of the combination travel luggage and booster seat 10, showing the pair of rear wheels 28b mounted on the rear legs 32 in an upright position wherein the pair of rear wheels 28b are adjacent a rear edge 35 of the luggage piece 20. As mentioned above, the wheels 28 further include the pair of forward wheels 28a that are mounted adjacent the forward edge 34 of the luggage piece 20. In some embodiments, the rear legs 32 are pivotally mounted on the luggage piece 20 to pivot between the upright position and a reclining position, the reclining position being shown in FIG. 5.

FIG. 5 is a side elevational view of the combination travel luggage and booster seat 10, showing the rear legs 32 in the reclining position wherein the pair of rear wheels 28b are spaced a distance D from the rear edge 35 of the luggage piece 20. The rear legs 32 may be pivotally mounted via a hinge, pivot mount, slider, or other mechanism suitable for partial detachment from the luggage piece 20. The rear legs 32 may serve as a support limb and stabilizer for handling the additional weight of the child in the booster seat 50. In this embodiment, the rear legs 32 extend from the back portion 36 of the luggage piece 20, but in other embodiments may extend from the sides or front of the luggage piece 20, or from any surface to enhance stability and support of the present invention 10.

In one embodiment, the rear legs 32 may pivot via a mechanism that allows castors of the wheels 28 to remain vertically oriented, so that the wheels 28 may rotate freely in any position. In another embodiment, the rear legs 32 may combine with at least two castors (not shown), such that the present invention 10 has at least two rotational castors and at least two directionally fixed castors. Therefore, when the rear legs 32 are in the reclining position, a user can easily roll the present invention 10 in any desired direction. In another embodiment, the wheels 28 may include wheel brakes with a brake release on castors or on the retractable handle 38 (not shown). The wheels 28 may further rotate outwardly.

Another embodiment of the booster seat 50 includes a cushion on the upper surface 55, and does not include the back support 52, so that a child may sit facing the opposite direction of the above-described method of use (not shown). In said reverse position, the cross-grip 46 shown in FIG. 3 may serve as a grip for the child riding on the booster seat 50. In some embodiments, the booster seat 50 may be removed entirely and the child may ride on the luggage piece 20 instead. In one embodiment (not shown), the booster seat 50 may have a carrying strap, so that a user may comfortably carry the booster seat 50 separately from the luggage piece 20.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A combination travel luggage and booster seat for carrying both belongings and a child, the combination comprising:
a luggage piece comprising:
a housing adapted to receive and contain the belongings;
wheels mounted on the housing;
a first securing mechanism mounted on the housing; and
a luggage handle attached to the housing; and
a booster seat comprising:
a seat adapted for the child to sit upon;
restraint straps attached to the booster seat adapted for holding the child on the seat;
a second securing mechanism on a bottom surface of the booster seat that removably engages the first securing mechanism of the luggage piece so that the booster seat may be removably mounted on the luggage piece; and
a release device for releasing the first and second securing mechanisms so that they may be disengaged for removing the booster seat from the luggage piece.

2. The combination of claim 1, wherein the seat further comprises a back support attached to the booster seat which extends upwardly from the seat to provide a front surface that is generally perpendicular to the upper surface of the seat.

3. The combination of claim 2, wherein the back support is hingedly attached to the booster seat so that it can move between a closed position over the seat, and an open position wherein the back support extends upwardly from the seat.

4. The combination of claim 3, wherein the back support comprises:
a cover plate hingably attached to the seat, the plate having an extension panel and a locking piece, the extension panel and locking piece being telescopically engaged with the cover plate, respectively;
wherein the back support moves from a closed position in which the extension panel and locking piece are recessed into the cover plate, and the cover plate is folded over the seat, to an open position in which the cover plate is generally perpendicular to the seat and the extension panel and locking piece are extended upwardly out of the cover plate; and
wherein the locking piece is adapted to engage with the grip portion of the retractable luggage handle.

5. The combination of claim 1, wherein the wheels include a pair of forward wheels that are mounted adjacent a forward edge of the luggage piece, and a pair of rear wheels which are mounted on rear legs, the rear legs being pivotally mounted on a back portion of the luggage piece to pivot between an upright position wherein the pair of rear wheels are adjacent a rear edge of the luggage piece, and a reclining position wherein the pair of rear wheels are spaced a distance away from the rear edge of the luggage piece.

6. A combination travel luggage and booster seat for carrying both belongings and a child, the combination comprising:
a luggage piece comprising:
a housing adapted to receive and contain the belongings;
wheels mounted on a lower portion of the housing;
a first securing mechanism mounted on an upper portion of the housing; and
a retractable luggage handle comprising a grip portion mounted on at least one rod which slidably engages with the housing; and
a booster seat comprising:
a seat having an upper surface adapted for the child to sit upon;
restraint straps attached to the booster seat adapted for holding the child on the seat;
a second securing mechanism on a bottom surface of the booster seat that removably engages the first securing mechanism of the luggage piece so that the booster seat may be removably mounted on the luggage piece; and
a release device for releasing the first and second securing mechanisms so that they may be disengaged for removing the booster seat from the luggage piece.

7. The combination of claim 6, wherein the seat further comprises a back support attached to the booster seat which extends upwardly from the seat to provide a front surface that is generally perpendicular to the upper surface of the seat.

8. The combination of claim 7, wherein the back support is hingedly attached to the booster seat so that it can move between a closed position over the seat, and an open position wherein the back support extends upwardly from the seat.

9. The combination of claim 8, wherein the back support comprises:
a cover plate hingably attached to the seat, the plate having an extension panel and a locking piece, the extension panel and locking piece being telescopically engaged with the cover plate, respectively;
wherein the back support moves from a closed position in which the extension panel and locking piece are recessed into the cover plate, and the cover plate is folded over the seat, to an open position in which the cover plate is generally perpendicular to the seat and the extension panel and locking piece are extended upwardly out of the cover plate; and
wherein the locking piece is adapted to engage with the grip portion of the retractable luggage handle.

10. The combination of claim 6, wherein the wheels include a pair of forward wheels that are mounted adjacent a forward edge of the luggage piece, and a pair of rear wheels which are mounted on rear legs, the rear legs being pivotally mounted on a back portion of the luggage piece to pivot between an upright position wherein the pair of rear wheels are adjacent a rear edge of the luggage piece, and a reclining position wherein the pair of rear wheels are spaced a distance away from the rear edge of the luggage piece.
